(19) United States
(12) Patent Application Publication
(10) Pub. No.: US 2013/0185609 A1
(43) Pub. Date: Jul. 18, 2013

(54) NONVOLATILE MEMORY SYSTEM

(71) Applicant: SAMSUNG ELECTRONICS CO., LTD., Suwon-si (KR)

(72) Inventors: Sang-Soo PARK, Hwaseong-si (KR); Jae-Yong JEONG, Yongin-si (KR)

(73) Assignee: SAMSUNG ELECTRONICS CO., LTD., Suwon-Si (KR)

(21) Appl. No.: 13/668,607

(22) Filed: Nov. 5, 2012

(30) Foreign Application Priority Data
Jan. 17, 2012 (KR) 10-2012-0005313

(51) Int. Cl. G06F 11/07

(52) U.S. Cl. 714/746; 714/E11.023; 714/E11.024

(57) ABSTRACT

A nonvolatile memory system is provided. The nonvolatile memory device includes a multi-level memory array and a page buffer; and a memory controller configured to control first page data to be to read from the multi-level memory array and stored in the page buffer, a first error bit of the first page data to be detected, an error of the first page data stored in the page buffer to be to corrected using first corrected data having an error corrected in the first error bit, and a first refresh program operation of the error-corrected first page data to be performed on the multi-level memory array.

### CROSS-REFERENCE TO RELATED APPLICATION

This application claims priority under 35 U.S.C. §119 to Korean Patent Application No. 10-2012-0005313 filed on Jan. 17, 2012 in the Korean Intellectual Property Office (KIPO), the entire contents of which are incorporated herein by reference.

### BACKGROUND

1. Field of the Inventive Concept

Example embodiments of the inventive concepts relates to a nonvolatile memory system.

2. Description of the Related Art

Storage capacity of a nonvolatile memory cell is gradually decreasing. As the size of the nonvolatile memory cell is scaled down, the number of electrons defining data “0” and data “1” is gradually reduced. Accordingly, in order to maintain the reliability of a nonvolatile memory, development of techniques for maintaining electrons in a programmed cell is under way.

A refresh program is one of the techniques for maintaining electrons in a programmed cell. For example, when no further information is read from a cell due to charge loss, a refresh program is performed to reprogram the information of the cell.

To perform a refresh program, first, a memory controller reads page data from a memory array included in a nonvolatile memory. After errors of the read page data are corrected, the memory controller may refresh the corrected page data on the memory array.

If a memory array of a nonvolatile memory device is a multi level cell (MLC) type, the memory array may include two or more pages. In detail, a word line included in the memory array may include two or more pages. Read and refresh programs of the memory array may be performed pagewise. Therefore, page data may be read for each page from the MLC type memory array and the read multiple page data may be corrected by the memory controller to then be stored in a register of the memory controller. The refresh-program of the corrected multiple page data may be performed on the memory array at once. In the course of performing the refresh program, it may be preferable for the corrected multiple page data to be stored in the register of the memory controller. Thus, it may be preferable for the memory controller to have a register capable of storing data of at least two pages.

However, as the number of pages included in the word line of the memory array increases, the number of registers of the memory controller should be increased, which may be a burden on the operation of the memory controller.

### SUMMARY

Example embodiments of the inventive concepts provide a nonvolatile memory system, which may minimize use of registers of a memory controller and perform a refresh program using a register of a nonvolatile memory.

The above and other objects of example embodiments of the inventive concepts will be described in or be apparent from the following description of the preferred embodiments.

According to an aspect of example embodiments of the inventive concepts, a nonvolatile memory system may include a nonvolatile memory device including a multi-level memory array and a page buffer, and a memory controller controlling first page data to be to read from the multi-level memory array to then be stored in the page buffer, a first error bit of the first page data to be detected, an error of the first page data stored in the page buffer to be to corrected using first corrected data having an error corrected in the first error bit, and a first refresh program of the error-corrected first page data to be performed on the multi-level memory array.

According to another aspect of example embodiments of the inventive concepts, a nonvolatile memory system may include a nonvolatile memory device including an array composed of multi-level memory cells each having least significant bit (LSB) page data and most significant bit (MSB) page data, and a memory controller controlling one of the LSB page data and the MSB page data to be firstly read, an error of the firstly read page data to be corrected and a first refresh program to be performed on the memory cell, the other of the LSB page data and the MSB page data to be secondly read, an error of the secondly read page data to be corrected and a second refresh program to be performed on the memory cell.

According to another aspect of example embodiments of the inventive concepts, a nonvolatile memory system may include a multi-level memory array; a page buffer; and a memory controller including a register. The memory controller may be configured to control operations including a reading operation including reading page data from the multi-level memory array and storing the page data in the page buffer, an error detection operation including detecting one or more error bits of the page data, an error correction operation including generating corrected data by correcting the one or more error bits, storing the corrected data in a register of the memory controller, and generating error-corrected page data based on the corrected data, and a refresh program operation including programming the error-corrected page data into multi-level memory array. Further, corrected data stored in the register of the memory controller may include only bits associated with the corrected one or more error bits, from among bits of the error corrected page data, and not all the bits of the error-corrected page data.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a nonvolatile memory system according to example embodiments of the inventive concepts;

FIG. 2 is a schematic diagram illustrating a memory array shown in FIG. 1;

FIG. 3 is a graph illustrating a threshold voltage distribution of a 2-bit multi level cell;

FIG. 4A is a flowchart for explaining a refresh programming method of a nonvolatile memory system according to example embodiments of the inventive concepts, and FIGS. 4B, 4C and 4D are graphs illustrating threshold voltage distributions of a 2-bit multi level cell in steps S1100, S1230 and S1330;

FIG. 5 is a timing diagram for explaining the refresh programming method of the nonvolatile memory system shown in FIG. 4A;

FIG. 6A is a flowchart for explaining a refresh programming method of a nonvolatile memory system according to example embodiments of the inventive concepts, and FIGS. 6B and 6C are graphs illustrating threshold voltage distributions of a 2-bit multi level cell in steps S2100 and S2360;

FIGS. 7 and 8 are timing diagrams for explaining the refresh programming method of the nonvolatile memory system shown in FIG. 6A;

FIG. 9A is a flowchart for explaining a refresh programming method of a nonvolatile memory system according to a third embodiment of example embodiments of the inventive concepts, and FIGS. 9B, 9C and 9D are graphs illustrating threshold voltage distributions of a 2-bit multi level cell in steps S3100, S3230 and S3330;

FIG. 10 is a graph illustrating a threshold voltage distribution of a 2-bit multi level cell;

FIG. 11A is a flowchart for explaining a refresh programming method of a nonvolatile memory system according to a fourth embodiment of example embodiments of the inventive concepts, and FIGS. 11B and 11C are graphs illustrating threshold voltage distributions of a 2-bit multi level cell in steps S4100 and S4360; and

FIG. 12 is a block diagram of a solid state disk (SDD) system including a nonvolatile memory system according to example embodiments of the inventive concepts.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Throughout the specification of example embodiments of the inventive concepts, for a better understanding, a nonvolatile memory system will be described with regard to a NAND flash memory, for example, but is not limited to a system using the NAND flash memory.

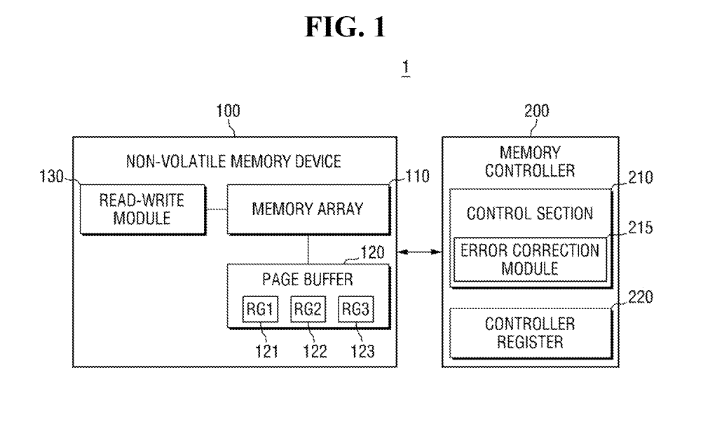

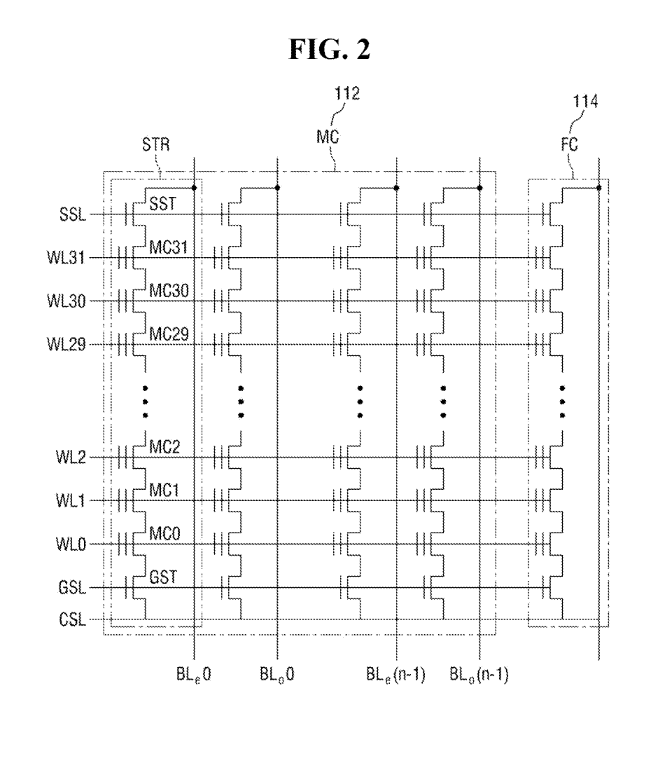

A nonvolatile memory system according to example embodiments of the inventive concepts will be described with reference to FIGS. 1 and 2. FIG. 1 is a block diagram of a nonvolatile memory system according to example embodiments of the inventive concepts and FIG. 2 is a schematic diagram illustrating a memory array shown in FIG. 1. Referring to FIG. 1, the nonvolatile memory system 1 may include a nonvolatile memory device 100 and a memory controller 200.

The memory controller 200 may be configured to perform read, write and refresh programs on the nonvolatile memory device 100. For example, the memory controller 200 may be configured to drive firmware or software for controlling the operation of the nonvolatile memory device 100.

The memory controller 200 may include a control section 210 including an error correction module 215, and a controller register 220. The control section 210 may control the overall driving operations of the nonvolatile memory system 1. For example, the control section 210 may control the read, write and refresh programs to be performed on the nonvolatile memory device 100. In addition, the error correction module 215 may correct an error of data read from the nonvolatile memory device 100. For example, the error correction module 215 may be an error correction code (ECC) engine that detects an error bit of the read data and corrects an error of the detected error bit using an error correction code.

For example, corrected data of the error bit may be stored in the controller register 220. Throughout the specification of example embodiments of the inventive concepts, the corrected data may be data having an error corrected in the detected error bit.

The nonvolatile memory device 100 may include a memory array 110, a page buffer 120, and a read-write module 130.

Referring to FIG. 2, the memory array 110 may have a string (STR) structure having a plurality of memory cells 112 in series connected to a bit line BL. In addition, the memory array 110 may be arranged to cross the word line WL and the bit line BL.

In addition, the memory array 110 may include the memory cells 112 storing N-bit data and a flag cell 114 storing flag data.

Each of the memory cells 112 may store 1-bit data or multi-bit data (e.g., data of two or more bits). Herein, a memory cell storing 1-bit data is referred to as a single-level cell (SLC) and memory cell storing multi-bit data is referred to as a multi-level cell (MLC).

If the memory cells 112 are MLCs, one of the memory cells 112 may a plurality of pages that are logically defined. Data of different levels or different bits may be stored in each page of the one of memory cells 112. For example, the memory cells 112 may be MLCs storing N-bit data. The N-bit data may include least significant bit (LSB) data and most significant bit (MSB) data. For example, the LSB data may be stored in a LSB page of the memory cells 112 and the MSB data may be stored in a MSB page of the memory cells 112.

Flag data is stored in the flag cell 114. The flag data indicates whether a particular page included in the memory cell 112 connected to the same word line WL as the flag cell 114 has been programmed or not. The flag data may be divided into MSB flag data (MF) and LSB flag data (LF). The MSB flag data (MF) programmed in the flag cell 114 indicates that the MSB page of the corresponding word line WL is programmed, and the LSB flag data (LF) programmed in the flag cell 114 indicates that the LSB page of the corresponding word line WL is programmed.

For example, the data read from the memory array 110 and data to be programmed in the memory array 110 may be stored in the page buffer 120. The page buffer 120 may include a plurality of data storage sections. For example, the page buffer 120 may include first to third registers 121, 122 and 123.

The read-write module 130 may read data from the memory array 110 or may write (or program) data on the memory array 110.

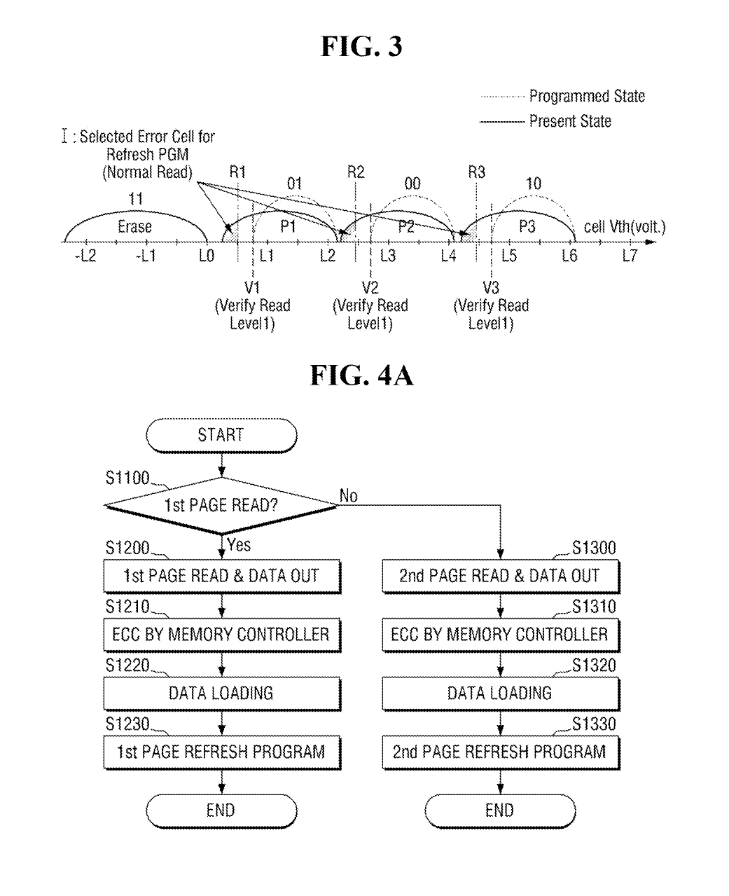

The desirability of for a refresh program will be described with reference to FIG. 3 illustrating a threshold voltage distribution according to the data stored in the memory cell. FIG. 3 is a graph illustrating a threshold voltage distribution of a 2-bit multi level cell (MLC)

Referring to FIG. 3, the 2-bit MLC may have a threshold voltage distribution of 4 states. In detail, the 4 states of the 2-bit MLC may include ‘11’ state (Erase), ‘01’ state P1, ‘00’ state P2, and ‘10’ state P3 according to the magnitude of the threshold voltage, which are, however, provided by way of example only for convenient explanation. The data values may vary according to the threshold voltage magnitude.

The threshold voltage distribution indicated by dotted lines is a threshold voltage distribution of a memory cell without loss in charges stored therein. In detail, the threshold voltages of ‘01’ state P1, ‘00’ state P2 and ‘10’ state P3, which are indicated by dotted lines, are greater than a first verify voltage V1, a second verify voltage V2, and a third verify voltage V3, respectively.

However, with the passage of time, the charges stored in the memory cell may be lost, so that the threshold voltage distribution of the memory cell may be changed into a threshold voltage distribution indicated by solid lines. Here, when the memory cell is read, error data may be output. For example, although the memory cell is programmed to have a threshold voltage distribution of ‘01’ state P1 indicated by a dotted line, the charges stored in the memory cell may be lost, so that the memory cell may have a threshold voltage distribution indicated by a solid line. An error-bearing region I of ‘01’ state P1 indicated by a solid line has a threshold voltage lower than a first read voltage (R1). Thus, when data is read from the memory cell, the read data may be “11”, rather than “01.” For example, erroneous data may be output.

Therefore, in order to maintain reliability of data stored in the memory cell, it is necessary to correct an error of the data read from the memory cell and to perform a refresh program of the error-corrected data on the memory cell.

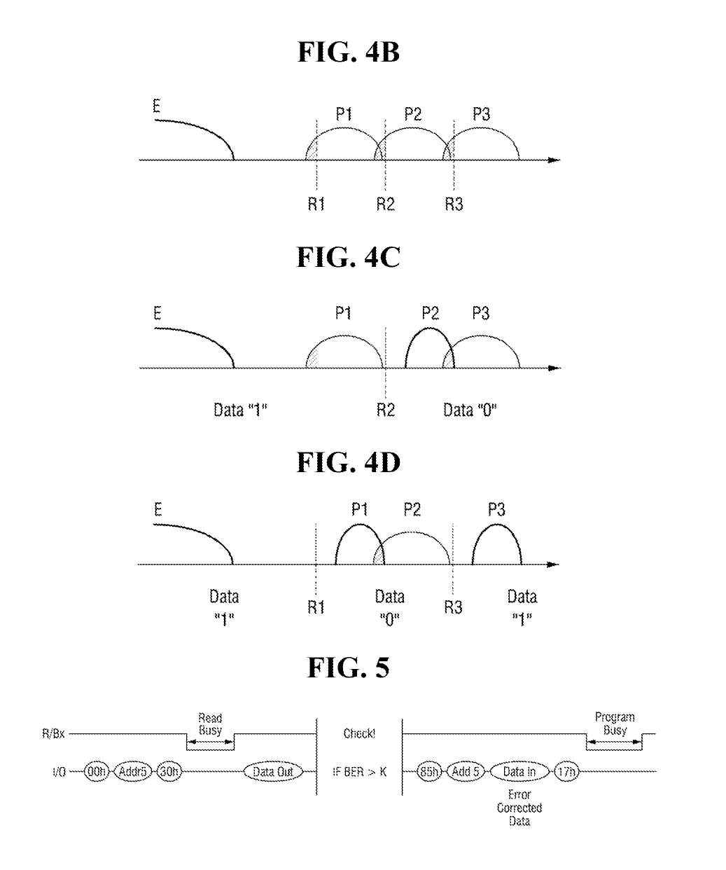

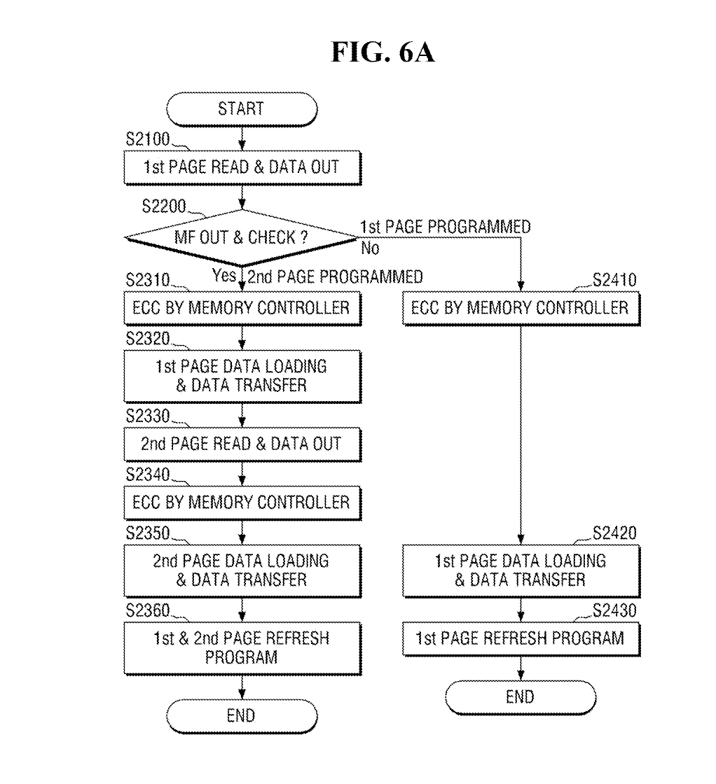

A method of performing a refresh program of a nonvolatile memory system according to example embodiments of the inventive concepts will be described with reference to FIGS. 1, 4A to 4D and 5. FIG. 4A is a flowchart for explaining a refresh programming method of a nonvolatile memory system according to example embodiments of the inventive concepts, and FIGS. 4B, 4C and 4D are graphs illustrating threshold voltage distributions of a 2-bit multi level cell in steps S1100, S1230 and S1330 of FIGS. 4A, and FIG. 5 is a timing diagram for explaining the refresh programming method of the nonvolatile memory system shown in FIG. 4A. In the following description of the method of performing a refresh program of a nonvolatile memory system according to example embodiments of the inventive concepts, the nonvolatile memory system 1 may be controlled by the control section 210 of the memory controller 200.

The memory array 110 may be a multi-level memory array. For example, the memory cells 112 included in the memory array 110 may be N-bit multi-level cells. The memory array 110 may include N pages in which data of different bits are stored. For example, the memory array 110 may include a first page storing LSB data and an Nth page storing MSB data.

The method of performing a refresh program of a nonvolatile memory system according to example embodiments of the inventive concepts will now be described in detail, for example, with regard to a case where the memory cell 112 included in the memory array 110 is a multi-level cell of 2 bits.

The LSB page storing the LSB data of 2 bits is defined as a first page and the MSB page storing the MSB data of 2 bits is defined as a second page.

In the method of performing a refresh program of a nonvolatile memory system according to example embodiments of the inventive concepts, a series of steps, including reading a particular page from the memory array 110, correcting an error of the read data, and performing a refresh program of the error-corrected data on the memory array 110, are performed separately and independently pagewise. For example, after the performing of the first page refresh program of the memory array 110 is completed, a second page refresh program may be performed on the memory array 110.

In the method of performing a refresh program of a nonvolatile memory system according to example embodiments of the inventive concepts, as described above, the first page refresh program of the memory array 110 and the second page refresh program of the memory array 110 may be performed separately and independently. In detail, after the first page data of the memory array 110 is read and error-corrected to then perform the refresh program on the memory array 110, the refresh program may be performed on the memory array 110 by reading second page data of the memory array 110 and performing error correction.

First, referring to FIGS. 1, 4A and 5, the control section 210 of the memory controller 200 may select data to be read from the memory array 110 (S1100). Here, either the first page or the second page of the memory array 110 may be selected, and a refresh program of the selected page may then be performed.

In a case where the first page of the memory array 110 is first read, the read-write module 130 may read the first page of the memory array 110 to then output first page data (S1200).

In detail, the control section 210 of the memory controller 200 may input read command sets 00h and 30h to the nonvolatile memory device 100 through an input/output (I/O) port. For example, the control section 210 may control the read-write module 130 to read the first page of the memory array 110. Address information Addr5 may be positioned between read command sets 00h and 30h to then be supplied to the nonvolatile memory device 100. In addition, the address information Addr5 may be composed of two column addresses and three row addresses.

The memory array 110 may be read in unit of one word line WL. Therefore, if the first page of the memory array 110 is read, first page data stored in the first page of the plurality of memory cells 112 connected to one word line WL may be output. The first page data may be stored in the first register 121 of the page buffer 120.

Next, an error of the first page data may be corrected using the error correction module 215 of the memory controller 200 (S1210).

The error correction module 215 may be, for example, an ECC engine, and may detect a first error bit of the first page data to then correct data error of the first error bit based on ECC. The error correction module 215 may correct the data error of the first error bit to generate first corrected data. The first corrected data may be stored in the controller register 220.

The first corrected data, rather than the error-corrected first page data, may be stored in the controller register 220. For example, data without an error bit in the first page data is not stored in the controller register 220, and only the first corrected data having an error corrected in first error bit may be stored in the controller register 220.

The first corrected data stored in the controller register 220 may have a smaller size than the first page data. If the size of the data stored in the controller register 220 is reduced, the number of controller registers 220 required may be reduced, thereby reducing the burden of the memory controller 200 due to the presence of the controller registers 220.

The error correction module 215 may calculate a bit error rate (BER) of the first page data and may compare the BER of the first page data with a predetermined or reference threshold value (K). The predetermined or reference threshold value K may be a value for the BER that can be accommodated in the nonvolatile memory system 1. Therefore, if the BER of the first page data is greater than the predetermined or reference threshold value K, the first page data may have error bits that cannot be accommodated in the nonvolatile memory system 1, the memory controller 200 may determine that a first page refresh program of the memory array 110 is necessarily performed. However, if the BER of the first page data is smaller than the predetermined or reference threshold value K, the operation of the nonvolatile memory system 1 for performing the refresh program may be interrupted.

Next, if the BER of the first page data is greater than the predetermined or reference threshold value K, the error of the first page data stored in the first register 121 may be corrected using the first corrected data. As a result, the corrected first page data may be loaded into the first register 121 (S1220).

In detail, the first corrected data is stored in the controller register 220 and the memory controller 200 has knowledge of an address of the first error bit of the first page data. Therefore, the error of the first page data stored in the first register 121 may be corrected using the address of the first error bit of the first corrected data. For example, the error bit of the first page data stored in the first register 121 can be corrected as a value of the first corrected data.

In the method of performing a refresh program of a nonvolatile memory system according to example embodiments of the inventive concepts, the control section 210 of the memory controller 200 supplies the first corrected data to the nonvolatile memory device 100 to correct the first page data using the first corrected data, and the corrected first page data is loaded into the first register 121. As described above, the memory controller 200 and the nonvolatile memory device 100 exchange the first corrected data having a relatively small size. Thus, compared to a case where the first page data corrected in the memory controller 200 is supplied to the nonvolatile memory device 100 a data input time and input/output (I/O) power can be reduced.

Next, a first page refresh program of the memory array 110 may be performed on the corrected first page data of the first register 121 (S1230).

However, the refresh program may be performed only on the memory cells 112 from which first error bits of the memory array 110 are detected. For example, the refresh program may be performed on the memory cells 112 having a threshold voltage corresponding to the error-bearing region I shown in FIG. 3. In addition, the refresh program may also be performed on the flag cell 114 while performing the first page refresh program on the of the memory array 110.

In detail, the control section 210 of the memory controller 200 may input refresh command sets 85h and 17h to the nonvolatile memory device 100 through the I/O port. For example, the control section 210 may control the read-write module 130 to perform a refresh program of the corrected first page data on the first page of the memory array 110. The address information Addr5 may be positioned between the refresh command sets 85h and 17h to be supplied to the nonvolatile memory device 100.

As described above, the first page means an LSB page to store LSB data. If the threshold voltage is lower than a second read voltage R2, the LSB data may be “1” and if the threshold voltage is higher than the second read voltage R2, the LSB data may be “0”. Referring to FIGS. 4B and 4C, as the result of the refresh program of the LSB page, the refresh program may be performed such that the threshold voltage of ‘00’ state P2 adjacent to the second read voltage R2 is a distributed to be higher than the second read voltage R2. Thus, even if the LSB data is read based on the second read voltage R2, an error may not be generated.

After the first page refresh program of the memory array 110 is completed, a second page refresh program of the memory array 110 may be performed. However, if only the first page of the memory array 110 is programmed, a second page refresh program of the memory array 110 may not be performed. Conversely, if only the second page of the memory array 110 is programmed, a first page refresh program of the memory array 110 may not be performed.

Since the second page refresh program is substantially the same as the first page refresh program, the following description will focus on differences therebetween.

First, if the read-write module 130 reads the second page of the memory array 110, second page data may be output (S1300).

The memory array 110 may be read in unit of one word line WL. Therefore, if the second page of the memory array 110 is read, second page data stored in the second page of the plurality of memory cells 112 connected to one word line WL may be output. The second page data may be stored in the first register 121 of the page buffer 120.

Next, an error of the second page data may be corrected using the error correction module 215 of the memory controller 200 (S1310).

The error correction module 215 may detect a second error bit of the second page data to then correct data error of the second error bit based on ECC, and may correct the data error of the second error bit to generate second corrected data. The second corrected data may be stored in the controller register 220.

The error correction module 215 may calculate a bit error rate (BER) of the second page data and may compare of the BER of the second page data with a predetermined or reference threshold value (K). If the BER of the second page data is smaller than the predetermined or reference threshold value K, the operation of the nonvolatile memory system 1 for performing the refresh program may be interrupted.

Next, if the BER of the second page data is greater than the predetermined or reference threshold value K, the error of the second page data stored in the first register 121 may be corrected using the second corrected data. As a result, the corrected second page data can be loaded into the first register 121 (S1320).

Next, a second page refresh program of the memory array 110 may be performed on the corrected second page data of the first register 121 (S1330).

However, the refresh program may be perforated only on the memory cells 112 from which second error bits of the memory array 110 are detected. The refresh program may also be performed on the flag cell 114 while performing the refresh program on the second page of the memory array 110.

As described above, the second page may be an MSB page to store MSB data. If the threshold voltage is distributed between the first and third read voltages R1 and R3, the MSB data may be “0” and if the threshold voltage is higher than the first read voltage R1 or lower than the third read voltage R3, the MSB data may be “1”. Referring to FIGS. 4B and 4D, as the result of the refresh program of the MSB page, the refresh program is performed such that the threshold voltage of ‘01’ state P1 adjacent to the first read voltage R1 is a distributed to be higher than the first read voltage R1 and the threshold voltage of ‘10’ state P3 adjacent to the third read voltage R3 is a distributed to be higher than the third read voltage R3. Thus, even if the MSB data is read based on the first and second read voltages R1 and R3, an error may not be generated.

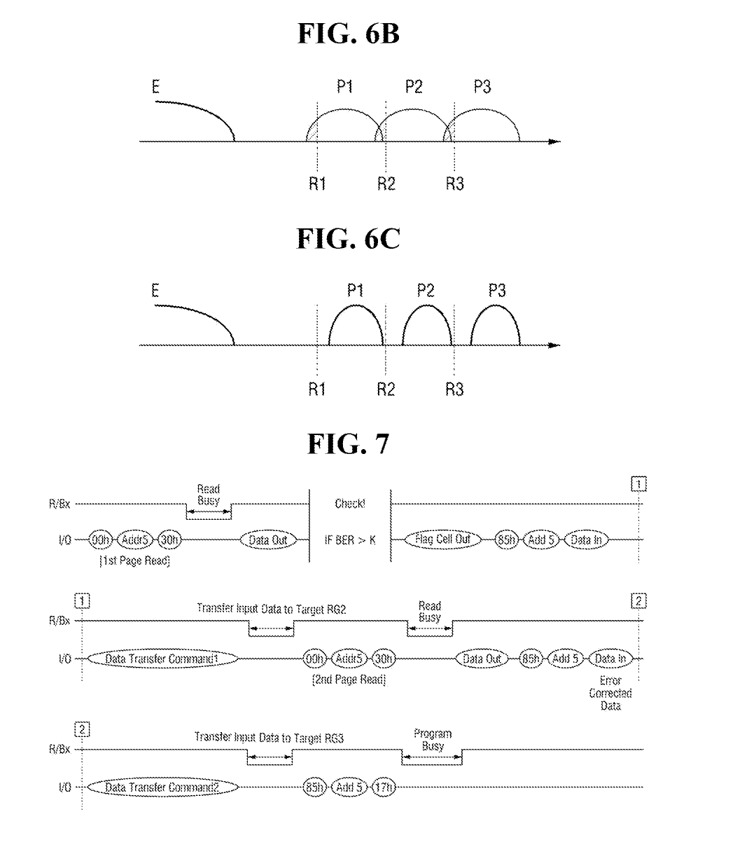

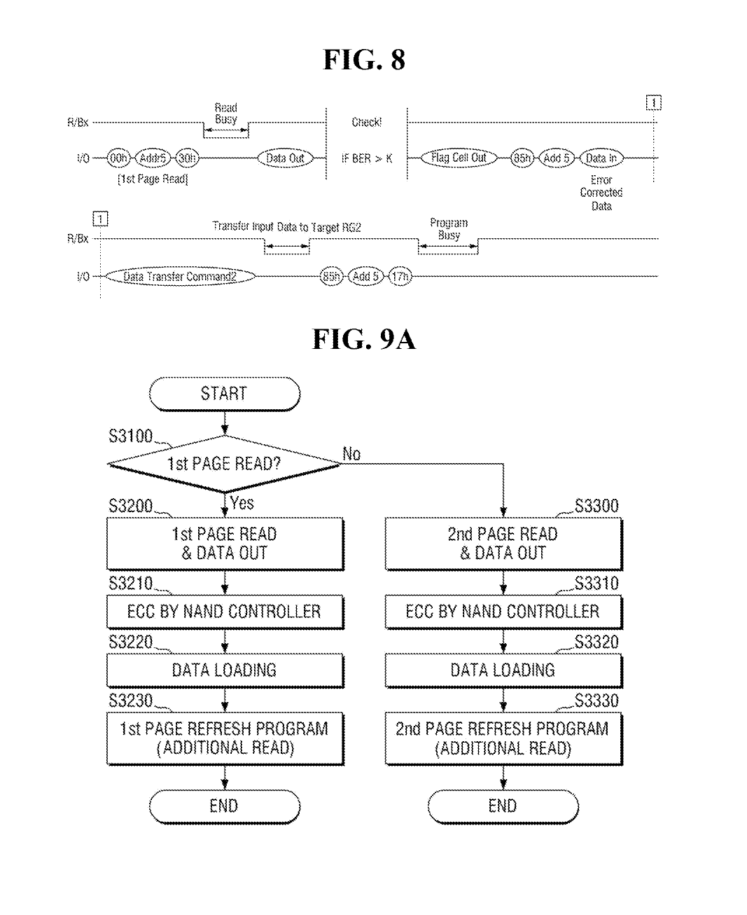

A method of performing a refresh program of a nonvolatile memory system according to example embodiments of the inventive concepts will be described with reference to FIGS. 6A to 6C and FIGS. 7 and 8. However, the following description will focus on differences between embodiments represented by FIGS. 6A to 6C, 7, and 8, and embodiments described above with reference to FIGS. 4A-5. FIG. 6A is a flowchart for explaining a refresh programming method of a nonvolatile memory system according to example embodiments of the inventive concepts, and FIGS. 6B and 6C are graphs illustrating threshold voltage distributions of a 2-bit multi level cell in steps S2100 and S2360 of FIG. 6A, and FIGS. 7 and 8 are timing diagrams for explaining the refresh programming method of the nonvolatile memory system shown in FIG. 6A.

In the following description of the method of performing a refresh program of a nonvolatile memory system according to example embodiments of the inventive concepts, the nonvolatile memory system 1 may be controlled by the control section 210 of the memory controller 200.

In the method of performing a refresh program of a nonvolatile memory system according to example embodiments of the inventive concepts, a series of steps, including reading a particular page, correcting an error of the read page data, and storing the error-corrected page data in a page buffer 120, are sequentially performed pagewise, and a refresh program of all pages is performed at once. For example, after the correcting of the page data read from the first to Nth pages and loading the error-corrected page data into the page buffer 120 are repeatedly performed, a refresh program of all pages may be performed at once.

The method of performing a refresh program of a nonvolatile memory system according to example embodiments of the inventive concepts will be described in detail with regard to a case where memory cells 112 included in a memory array 110 are 2-bit multi-level cells (MLCs).

First, referring to FIGS. 1 and FIGS. 6A and 7, if a read-write module 130 reads a first page of the memory array 110, first page data may be output (S2100).

The memory array 110 may be read in unit of one word line WL. Therefore, if the first page of the memory array 110 is read, first page data stored in the first page of the plurality of memory cells 112 connected to one word line WL may be output. The first page data may be stored in a first register 121 of a page buffer 120.

Next, a value of MSB flag data (MF) of the flag data of a cell 114 stored in the first register 121 is identified, thereby determining whether the MSB flag data (MF) is programmed in a second page of the memory array 110 or not (S2200). For example, if the value of the MSB flag data (MF) is “1,” it is determined that the MSB flag data MF is programmed in the second page, and if the value of the MSB flag data MF is “0,” it is determined that the MSB flag data MF is not programmed in the second page.

If it is determined that the MSB flag data MF is programmed in the second page by identifying the value of the MSB flag data MF, an error of first page data can be corrected using the error correction module 215 of the memory controller 200 (S2310). A case where it is determined that the MSB flag data MF is not programmed in the second page of the memory array 110 will later be described.

The error correction module 215 may detect a first error bit of the first page data to then correct data error of the first error bit based on ECC. The error correction module 215 corrects the data error of the first error bit to generate first corrected data. The first corrected data may be stored in the controller register 220.

The error correction module 215 may calculate a bit error rate (BER) of the first page data and may compare the BER of the first page data with a predetermined or reference threshold value (K). If the BER of the first page data is smaller than the predetermined or reference threshold value K, the operation of the nonvolatile memory system 1 for performing the refresh program may be interrupted.

Next, if the BER of the first page data is greater than the predetermined or reference threshold value K, the error of the first page data stored in the first register 121 may be corrected using the first corrected data, and the corrected first page data may be transferred to then be stored in the second register 122 of the page buffer 120. As a result, the corrected first page data may be loaded into the first register 121 and the corrected first page data is transferred to be stored in the second register 122 (S2320).

In detail, the control section 210 may input a command set 85h and address information Addr5 to the nonvolatile memory device 100, and the error-corrected first page data may be loaded into the first register 121. In addition, the control section 210 may input a data transfer command 1 to the nonvolatile memory device 100, and the error-corrected first page data may be loaded into the second register 122.

The reason of transferring the corrected first page data to a different register is to use the first register 121 in a different stage when the first register 121 of the page buffer 120 is used as a cache register. For example, if different data is stored in the first register 121, the corrected first page data stored in the first register 121 may be erased. Thus, the corrected first page data for a refresh program may be transferred to the second register 122.

Next, a second page of the memory array 110 is read to output second page data (S2330).

The memory array 110 may be read in unit of one word line WL. Therefore, if the second page of the memory array 110 is read, second page data stored in the second page of the plurality of memory cells 112 connected to one word line WL may be output. The corrected first page data may be transferred to then be stored in the second register 122 of the page buffer 120, and the output second page data may be stored in the first register 121 of the page buffer 120.

Next, an error of the second page data may be corrected using the error correction module 215 of the memory controller 200 (S2340).

The error correction module 215 may detect a second error bit of the second page data to then correct data error of the second error bit based on ECC. The error correction module 215 corrects the data error of the second error bit and generates second corrected data. The second corrected data may be stored in the controller register 220.

However, in the above-described steps, since the BER of the first page data is greater than a predetermined or reference threshold value K, the memory controller 200 determines that a refresh program is necessarily performed, and comparing the BER of the second page data with the predetermined or reference threshold value K may be skipped.

Next, the error of the second page data stored in the first register 121 may be corrected using the second corrected data, and the corrected second page data is transferred to then be stored in the third register 123 of the page buffer 120. As a result, the corrected second page data may be loaded into the first register 121 and the corrected second page data is transferred to be stored in the third register 123 (S2350).

Next, first and second page refresh programs of the memory array 110 may be performed on the corrected first page data stored in the second register 122 and the corrected second page data stored in the third register 123 (S2360).

However, the refresh programs may be performed only on the memory cells 112 from which first and second error bits of the memory array 110 are detected. For example, the refresh program may be performed on the memory cells 112 having a threshold voltage corresponding to the error-bearing region I shown in FIG. 3. In addition, the refresh program may also be performed on the flag cell 114 while performing the first and second page refresh programs on the of the memory array 110.

As described above, the first page may be an LSB page to store LSB data and the second page may be an MSB page to store MSB data. The LSB and MSB data may be read based on first to third read voltages R1, R2 and R3. Referring to FIGS. 6A and 6B, as the result of the refresh program of the LSB and MSB pages, the refresh program may be performed such that the threshold voltages of ‘01’ state P1, ‘00’ state P2 and ‘10’ state P3 are distributed to be higher than the first to third read voltages R1, R2 and R3. Thus, even if the LSB and MSB data are read based on the first to third read voltages R1, R2 and R3, an error may not be generated.

A method of performing a refresh program of a nonvolatile memory system according to example embodiments of the inventive concepts will be described with reference to FIGS. 1, 6A and 8 with regard to a case where the second page of the memory array 110 is not programmed. In this case, since the second page of the memory array 110 is not programmed, a second page read operation is not necessarily performed and a second page refresh program of the memory array 110 is not necessarily performed, either.

First, the error of the first page data may be corrected using the error correction module 215 of the memory controller 200 (S2410).

The error correction module 215 may detect a first error bit of the first page data to then correct data error of the first error bit based on ECC, and may correct the data error of the first error bit to generate first corrected data. The first corrected data may be stored in the controller register 220.

The error correction module 215 may calculate a bit error rate (BER) of the first page data and may compare the BER of the first page data with a predetermined or reference threshold value (K). If the BER of the first page data is smaller than the predetermined or reference threshold value K, the operation of the nonvolatile memory system 1 for performing the refresh program may be interrupted.

Next, if the BER of the first page data is greater than the predetermined or reference threshold value K, the error of the first page data stored in the first register 121 can be corrected using the first corrected data. The corrected first page data may be transferred to then be stored in the second register 122 of the page buffer 120. As a result, the corrected first page data may be loaded into the first register 121, and transferred to then be stored in the second register 122 (S2420).

Next, a first page refresh program of the memory array 110 may be performed on the corrected first page data of the second register 122 (S2430).

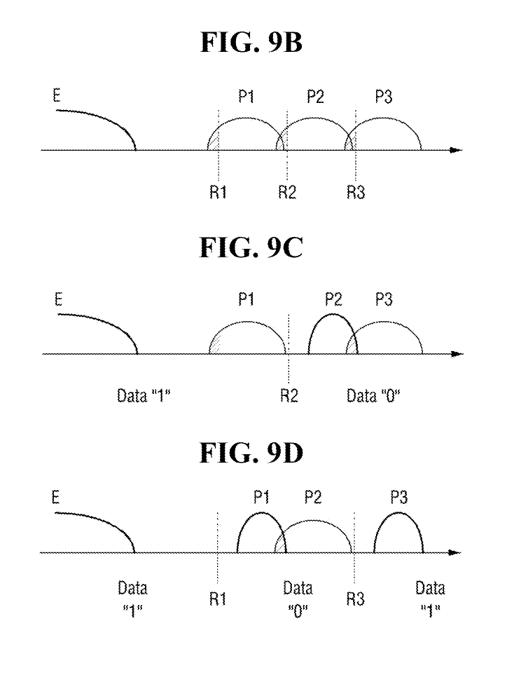

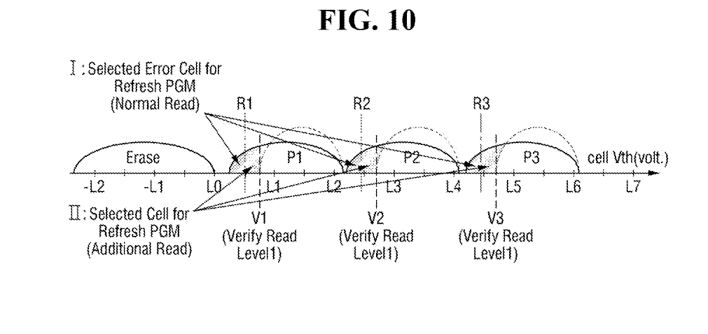

A method of performing a refresh program of a nonvolatile memory system according to example embodiments of the inventive concepts will be described with reference to FIGS. 9A to 9D and FIG. 10. However, the following description will focus on differences between embodiments represented by FIGS. 9A to 9D and FIG. 10, and embodiments described above with reference to FIGS. 6A to 6C, 7, and 8. FIG. 9A is a flowchart for explaining a refresh programming method of a nonvolatile memory system according to example embodiments of the inventive concepts, and FIGS. 9B, 9C and 9D are graphs illustrating threshold voltage distributions of a 2-bit multi level cell in steps S3100, S3230 and S3330 of FIG. 9A, and FIG. 10 is a graph illustrating a threshold voltage distribution of a 2-bit multi level cell.

Steps S3100, S3200, S3210, S3300, and S3310 may be performed in the same manner discussed above with reference to steps S1100, S1200, S1210, S1300 and S1310, respectively.

It may be preferable to perform the refresh program because a loss in charges stored in memory cells may be generated with the passage of time. The memory cell for which performing of a refresh program may be preferable is a memory cell that has an error or is prone to error due to a large amount of charge loss when data of the memory cell is read. For example, when the memory cell having a threshold voltage adjacent to the first to third read voltages R1, R2 and R3 is read using the first to third read voltages R1, R2 and R3, since it may have an error or may be prone to error, it may be preferable to perform a refresh program of the memory cell.

However, even if there is a charge loss, the memory cell having a considerably high threshold voltage compared to the first to third read voltages R1, R2 and R3 may be unlikely to have an error when data is read. Therefore, a refresh program may not be performed on the memory cell having a considerably higher threshold voltage than the first to third read voltages R1, R2 and R3, which correspond to, for example, first to third verify voltages V1, V2 and V3. In such a manner, efficiency of the refresh programs may be increased by suppressing unnecessary refresh programs, and power consumption of the nonvolatile memory system 1 may be reduced.

Therefore, referring to FIGS. 9A and 10, the refresh programming method of a nonvolatile memory system according to a third embodiment of example embodiments of the inventive concepts may include loading corrected page data, and additionally reading a page of the memory array 110 before performing a refresh program. For example, the page of the memory array 110 may be additionally read using a verify voltage, and a memory cell having a threshold voltage lower than the verify voltage may be detected. In detail, a memory cell having a threshold voltage between the read voltage and the verify voltage may be detected. In addition, refresh programs may be performed only on the memory cell 112 having a threshold voltage between the read voltage and the verify voltage read voltage and the memory cells 112 from which error bits are detected. Here, the verify voltage may be higher than the read voltage.

In the method of performing a refresh program of a nonvolatile memory system according to the third embodiment of example embodiments of the inventive concepts, refresh programs may be performed on all of the memory cells 112 having threshold voltages corresponding to an error-bearing region I and an error-risk region II, the threshold voltage of each of the memory cells 112 may be made to be greater than the verify voltage. Since the threshold voltage of each of the memory cells 112 may be considerably higher than the read voltage, the reliability of data stored in the memory array 110 may be increased.

The method of performing a refresh program of a nonvolatile memory system according to the third embodiment of example embodiments of the inventive concepts may include loading corrected first page data (S3220), and the nonvolatile memory device 100 may additionally read the first page of the memory array 110 using a verify voltage before performing the first page refresh program of the memory array 110 (S3230).

The verify voltage may be the second verify voltage V2, and the second verify voltage V2 may be higher than the second read voltage R2 used when the first page of the memory array 110 is read. The nonvolatile memory device 100 may detect the memory cell having the threshold voltage corresponding to the error-risk region II having a threshold voltage between the second read voltage R2 and the second verify voltage V2.

Next, the refresh program may be performed only on the memory cell having the threshold voltage between the second read voltage R2 and the second verify voltage V2 and the memory cell from which error bits are detected (S3230).

In addition, the method of performing a refresh program of a nonvolatile memory system according to the third embodiment of example embodiments of the inventive concepts may include loading corrected second page data (S3320), the nonvolatile memory device 100 may additionally read the second page of the memory array 110 using the verify voltage before performing the second page refresh program of the memory array 110 (S3330).

The verify voltage may be the first or third verify voltage V1 or V3, and the first or third verify voltage V1 or V3 may be higher than the second read voltage R2 used when the second page of the memory array 110 is read. The nonvolatile memory device 100 may detect the memory cell having a threshold voltage between the first read voltage R1 and the first verify voltage V1 or between the third read voltage R3 and the third verify voltage V3.

Next, the refresh program may be performed only on the memory cell detected by the additionally reading and the memory cell from which error bits are detected (S3330).

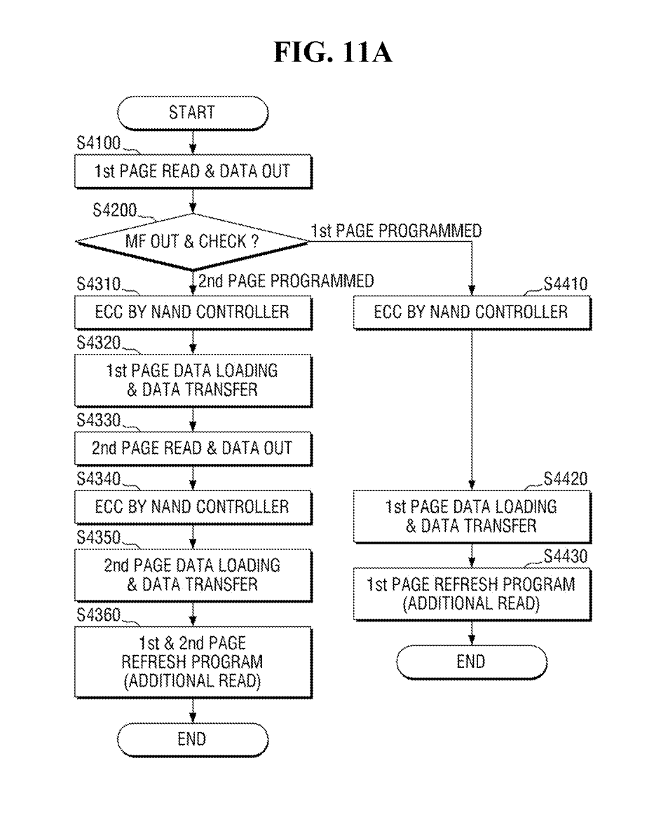

A method of performing a refresh program of a nonvolatile memory system according to a fourth embodiment of example embodiments of the inventive concepts will be described with reference to FIGS. 10 and 11A to 11C. However, the following description will focus on differences between embodiments represented by FIGS. 11A-11C, and embodiments described above with reference to FIGS. 4A-5. FIG. 11A is a flowchart for explaining a refresh programming method of a nonvolatile memory system according to a fourth embodiment of example embodiments of the inventive concepts, and FIGS. 11B and 11C are graphs illustrating threshold voltage distributions of a 2-bit multi level cell in steps S4100 and S4360 of FIG. 11A.

Steps S4100, S4200, S4310, 4320, S4330, S4340, and S4410 may be performed in the same manner discussed above with reference to steps S2100, S2200, S2310, S2320, S2330, S2340, and S2410, respectively.

In the method of performing a refresh program of a nonvolatile memory system according to a fourth embodiment of example embodiments of the inventive concepts, corrected second page data may be transferred (S4350). Before performing first and second page refresh programs of the memory array 110, the nonvolatile memory device 100 may further read first and second pages of the memory array 110 using a verify voltage (S4360).

In addition, in the method of performing a refresh program of a nonvolatile memory system according to a fourth embodiment of example embodiments of the inventive concepts, corrected first page data may be transferred (S4420). Before performing the first page refresh program of the memory array 110, the nonvolatile memory device 100 may further read a first page of the memory array 110 using a verify voltage (S4430).

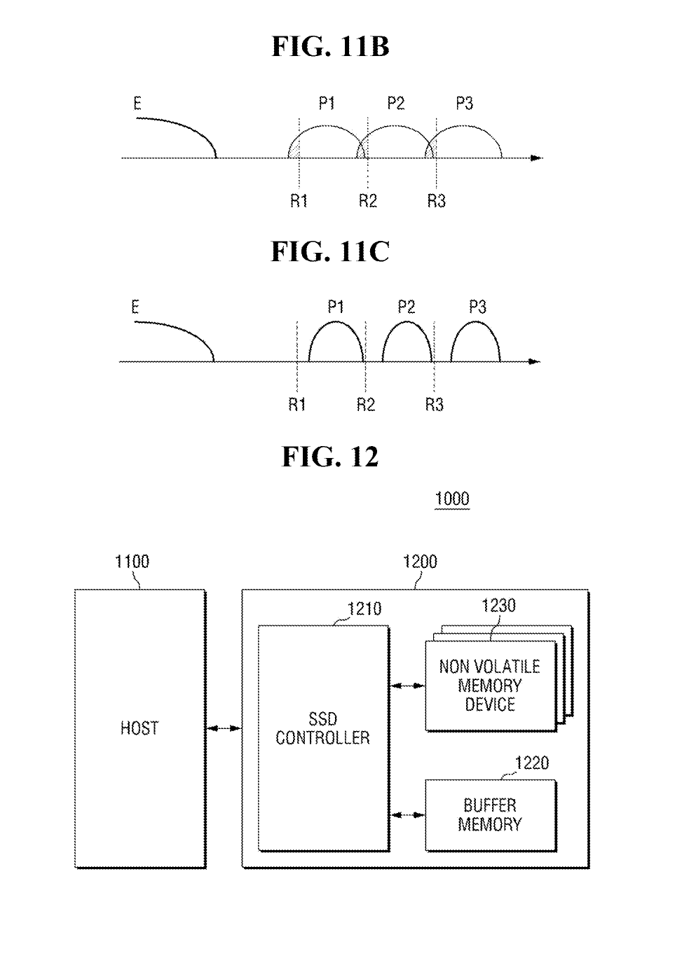

A solid state disk (SDD) system 1000 including a nonvolatile memory system according to example embodiments of the inventive concepts will be described with reference to FIG. 12. FIG. 12 is a block diagram of a solid state disk (SDD) system including a nonvolatile memory system according to example embodiments of the inventive concepts. Referring to FIG. 12, the SSD system 1000 may include a host 1100 and an SSD 1200. The SSD 1200 may include an SSD controller 1210, a buffer memory 1220, and a nonvolatile memory device 1230.

The SSD controller 1210 may provide a physical connection between the host 1100 and the SSD 1200. The buffer memory 1220 may be configured by a synchronous DRAM to offer a sufficient buffering operation of the SSD 1200. However, the synchronous DRAM is provided only for illustration. The buffer memory 1220 is not limited to the synchronous DRAM and may have various types of memories.

The nonvolatile memory device 1230 may be used as a main memory. To this end, the nonvolatile memory device 1230 may be configured by a NAND-type flash memory having a large storage capacity. However, the nonvolatile memory device 1230 provided in the SSD 1200 is not limited to the NAND flash memory. For example, the nonvolatile memory device 1230 may include a NOR-type flash memory, a hybrid flash memory having at least two memory cells, and a one-NAND flash memory having a controller incorporated into a memory chip. A plurality of channels may be provided in the SSD 1200 and a plurality of nonvolatile memory devices 1230 may be connected to the respective channels.

The SSD controller 1210 and the nonvolatile memory device 1230 shown in FIG. 12 may be configured in the same or substantially the same manner as the nonvolatile memory system 1 shown in FIG. 1.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims. example embodiments of the inventive concepts example embodiments of the inventive concepts

What is claimed is:

1. A nonvolatile memory system comprising:
a nonvolatile memory device including a multi-level memory array and a page buffer; and
a memory controller configured to control first page data to be to read from the multi-level memory array and stored in the page buffer, a first error bit of the first page data to be detected, an error of the first page data stored in the page buffer to be to corrected using first corrected data having an error corrected in the first error bit, and a first refresh program operation of the error-corrected first page data to be performed on the multi-level memory array.

2. The nonvolatile memory system of claim 1, the memory controller is further configured such that wherein the first corrected data has a smaller size than the first page data.

3. The nonvolatile memory system of claim 2, wherein the memory controller includes a controller register, and is further configured to control the first corrected data to be stored in the controller register after detecting the first error bit and before correcting errors of the first page data.

4. The nonvolatile memory system of claim 1, wherein the page buffer includes first and second registers, and the memory controller is further configured such that the first page data is stored in the first register of the page buffer, the memory controller transfers the error-corrected first page data before performing the first refresh program operation, and the memory controller controls the error-corrected first page data to be stored in the second register.

5. The nonvolatile memory system of claim 4, wherein the memory controller is further configured such that the memory controller control
second page data to be read from the multi-level memory array after storing the error-corrected first page data in the second register and before performing the first refresh program operation to then be stored in the first register,
a second error bit of the second page data to be detected, and
an error of the second page data stored in the first register to be corrected using second corrected data having an error corrected in the second error bit, and
the performing of the first refresh program operation includes performing the first refresh program operation of the error-corrected first page data and the error-corrected second page data on the multi-level memory array.

6. The nonvolatile memory system of claim 5, wherein the page buffer further includes a third register, and the memory controller is further configured to transfer the error-corrected second page data after correcting the error of the second page data stored in the first register and before performing the first refresh program operation and control the error-corrected second page data to be stored in the third register.

7. The nonvolatile memory system of claim 5, wherein the memory controller is configured such that the second corrected data has a smaller size than the second page data.

8. The nonvolatile memory system of claim 1, wherein the memory controller is configured to control
the second page data to be read from the multi-level memory array after performing the first refresh program operation,
the error of the second page data to be corrected, and
the second refresh program operation of the error-corrected second page data to be performed on the multi-level memory array.

9. The nonvolatile memory system of claim 1, wherein the multi-level memory array includes a plurality of multi-level memory cells and the memory controller is further configured to control the first refresh program operation to be performed on a first multi-level memory cell having the first error bit, among the multi-level memory cells.

10. The nonvolatile memory system of claim 9, wherein the memory controller is configured such that the multi-level memory array is read using a verify voltage before performing the first refresh program operation, a second multi-level memory cell having a threshold voltage lower than the verify voltage is detected among the multi-level memory cells, and the memory controller controls the first and second multi-level memory cells to perform the first refresh program operation.

11. The nonvolatile memory system of claim 10, wherein the memory controller is configured such that the reading of first page data from the multi-level memory array includes reading first page data from the multi-level memory array using a read voltage, and the verify voltage is higher than the read voltage.

12. A nonvolatile memory system comprising:
a nonvolatile memory device including an array, the array including multi-level memory cells each having least significant bit (LSB) page data and most significant bit (MSB) page data; and
a memory controller configured to control
a first reading operation including reading first data, the first data being one of the LSB page data and the MSB page data,
an error of the first data to be corrected and a first refresh program operation to be performed on the memory cell,
a second reading operation including reading second data, the second data being the other of the LSB page data and the MSB page data,
an error of the second data to be corrected, and
a second refresh program operation to be performed on the memory cell.

13. The nonvolatile memory system of claim 12, wherein the nonvolatile memory device further comprises:
a page buffer,
wherein the first reading operation includes reading the first data, outputting the first data as first page data, storing the first page data in the page buffer,
wherein the memory controller is further configured to control detecting a first error bit of the first page data, and
wherein the correcting the error of the first data includes correcting an error of the first data stored in the page buffer using first corrected data having an error corrected in the first error bit.

14. The nonvolatile memory system of claim 13, wherein the memory controller includes a controller register, and wherein the memory controller is further configured to control storing the first corrected data in the controller register after the detecting the first error bit and before the correcting the error of the first data.

15. The nonvolatile memory system of claim 13, wherein the memory controller is configured such that the first corrected data has a smaller size than the first page data.

16. A nonvolatile memory system comprising:
a multi-level memory array;
a page buffer; and
a memory controller including a register,
wherein the memory controller is configured to control operations including,
a reading operation including reading page data from the multi-level memory array and storing the page data in the page buffer,
an error detection operation including detecting one or more error bits of the page data,
an error correction operation including generating corrected data by correcting the one or more error bits, storing the corrected data in a register of the memory controller, and generating error-corrected page data based on the corrected data, and
a first refresh program operation including programming the error-corrected page data into multi-level memory array, and
wherein corrected data stored in the register of the memory controller includes only bits associated with the corrected one or more error bits, from among bits of the error corrected page data, and all the bits of the error-corrected page data.

17. The nonvolatile memory system of claim 16, wherein the memory controller is further configured such that the error correction operation includes storing the corrected data in the register of the memory controller after detecting the one or more first error bits and before generating the error-corrected page data.
